(19) United States
(12) Patent Application Publication
(10) Pub. No.: US 2012/0095643 A1
(43) Pub. Date: Apr. 19, 2012

(54) Method, Apparatus, and Computer Program Product for Modifying a User Interface Format

(75) Inventors: Raja Bose, Mountain View, CA (US); Jörg Brakensiek, Mountain View, CA (US)

(73) Assignee: Nokia Corporation

(21) Appl. No.: 12/907,616

(22) Filed: Oct. 19, 2010

(51) Int. Cl. G06F 19/00; G06F 3/01

(52) U.S. Cl. 701/32.8; 715/744; 701/415

(57) ABSTRACT

Various methods for modifying a user interface format are provided. One example method comprises receiving vehicle-based data at a mobile device via a communications link between the mobile device and an on-board vehicle analysis system, determining an environmental context based at least on the vehicle-based data, and modifying a user interface format based on the determined environmental context. Similar and related example methods, example apparatuses, and example computer program products are also provided.

### TECHNICAL FIELD

Embodiments of the present invention relate generally to implementing a user interface, and, more particularly, relate to a method, apparatus, and computer program product for modifying a user interface format.

### BACKGROUND

As mobile computing and communications devices become increasingly flexible and convenient, users of the devices have become increasingly reliant on the functionality offered by the devices in a variety of settings. Due to advances made in data storage capabilities, communications capabilities, and processing power, the functionality offered by mobile devices continues to evolve. As new functionalities are introduced or become popular, the user demand for convenient, intuitive, and user-friendly user interface techniques also increases. To meet the demands of users or encourage utilization of new functionality, innovation in the design and operation of user interfaces must keep pace.

### SUMMARY

Example methods, example apparatuses, and example computer program products are described herein that provide for modifying a user interface format, for example, based on vehicle-based data for the convenience of a user that may be driving a vehicle. One example method comprises receiving vehicle-based data at a mobile device via a communications link between the mobile device and an on-board vehicle analysis system, determining an environmental context based at least on the vehicle-based data, and modifying a user interface format based on the determined environmental context.

An additional example embodiment is an apparatus configured to modify a user interface format. The example apparatus may comprise at least one processor and at least one memory including computer program code, the at least one memory and the computer program code configured to, with the at least one processor, direct the apparatus to perform various functionalities. In this regard, the example apparatus may be directed to receive vehicle-based data at a mobile device via a communications link between the mobile device and an on-board vehicle analysis system, determine an environmental context based at least on the vehicle-based data, and modify a user interface format based on the determined environmental context.

Another example embodiment is a computer program that, when executed causes an apparatus to perform functionality. In this regard, the computer program, when executed may cause, an apparatus to receive vehicle-based data at a mobile device via a communications link between the mobile device and an on-board vehicle analysis system, determine an environmental context based at least on the vehicle-based data, and modify a user interface format based on the determined environmental context.

Another example embodiment is a computer program product comprising a non-transitory memory having computer program code stored thereon, wherein the computer program code is configured to direct an apparatus to perform various functionalities. In this regard, the program code may be configured to direct the apparatus to receive vehicle-based data at a mobile device via a communications link between the mobile device and an on-board vehicle analysis system, determine an environmental context based at least on the vehicle-based data, and modify a user interface format based on the determined environmental context.

Another example apparatus comprises means for performing various functionalities. In this regard, the apparatus may include means for receiving vehicle-based data at a mobile device via a communications link between the mobile device and an on-board vehicle analysis system, means for determining an environmental context based at least on the vehicle-based data, and means for modifying a user interface format based on the determined environmental context.

### BRIEF DESCRIPTION OF THE DRAWING(S)

Having thus described example embodiments of the invention in general terms, reference will now be made to the accompanying drawings, which are not necessarily drawn to scale, and wherein:

FIG. 1 illustrates an example system for modifying a user interface format for use with an in-vehicle information system according to an example embodiment of the present invention;

FIG. 2 illustrates an example interface for sharing user interface data between a mobile device and an in-vehicle information system according to an example embodiment of the present invention;

FIG. 3 illustrates a flow chart for modifying a user interface format based on vehicle-based speed data according to an example embodiment of the present invention;

FIG. 4 illustrates a flow chart for modifying a user interface format based on vehicle-based ambient light data according to an example embodiment of the present invention;

FIG. 5 illustrates a flow chart for modifying a user interface format based on vehicle-based ambient noise data according to an example embodiment of the present invention;

FIG. 6 illustrates a flow chart for modifying a user interface format based on a combination of vehicle-based data parameters according to an example embodiment of the present invention;

FIG. 7 illustrates a block diagram of an apparatus and associated system for modifying a user interface format according to some example embodiments of the present invention;

FIG. 8 illustrates a block diagram of a mobile terminal configured for modifying a user interface format according to some example embodiment of the present invention; and

FIG. 9 is a flow chart of an example method for modifying a user interface format according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Various example embodiments of the present invention relate to methods, apparatuses, and computer program products for modifying a user interface format established by a mobile device that is providing or projecting the user interface format and content that is to a remote environment, such as an in-vehicle information system. According to various example embodiments, the user interface format may be modified based on information acquired by the mobile device from a vehicle, and more particularly, from an on-board vehicle analysis system, such as, for example, an on-board diagnostic (OBD) system.

The remote environment, which may receive and present the user interface format and content provided by a mobile device, may be any type of computing device configured to display an image, provide audible output, and/or receive user input (e.g., via a keypad, a touch screen, multi-functional knob, a microphone, or the like). The remote environment may be installed in a vehicle (e.g., automobile, truck, bus, boat, plane, or the like) as an in-vehicle information system. Examples of in-vehicle information systems may include in-vehicle infotainment (IVI) systems, for example, installed in a vehicle dashboard or ceiling, or heads-up displays (HUDs) that project content onto transparent glass, such as the windshield of the vehicle. An in-vehicle information system may include one or more touch or non-touch displays, keypads, knob controls, steering wheel mounted controls, audio recording and playback systems, and other optional devices such as parking cameras and global positioning system (GPS) functionality. In some example embodiments, an in-vehicle information system may include a touch screen display that is configured to receive input from a user via touch events with the display. Further, an in-vehicle information system may include gaming controllers, speakers, a microphone, and the like. As such, according to some example embodiments, in-vehicle information systems may include user interface components and functionality. An in-vehicle information system may also include a communications interface for communicating with a mobile device via a communications link. While example embodiments described herein are placed within a vehicle, it is also contemplated that embodiments of the present invention may be implemented where the remote environment is external to the vehicle.

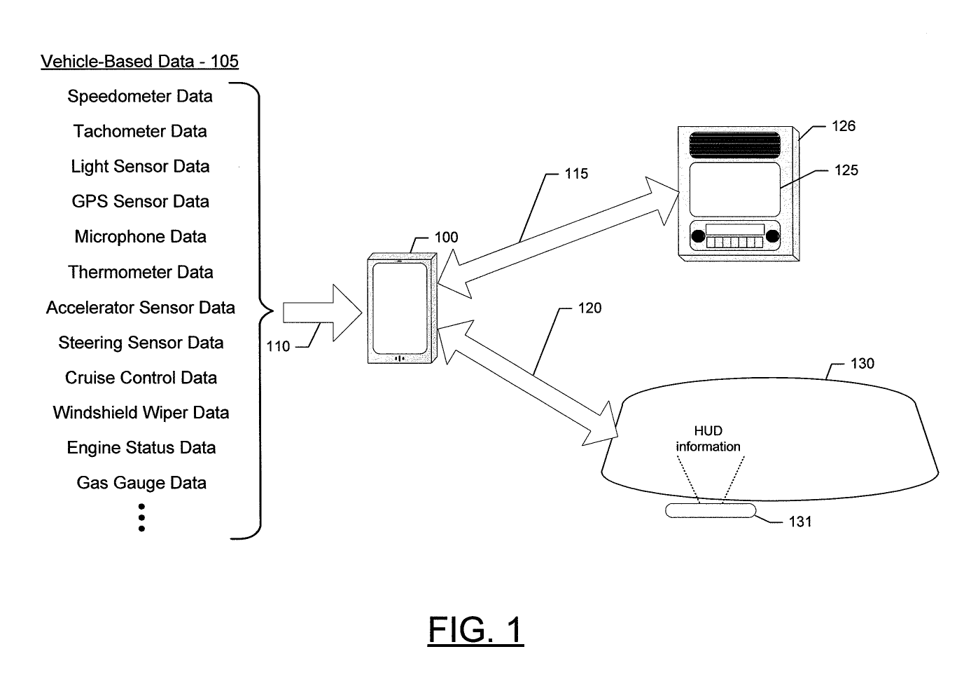

FIG. 1 illustrates an example system including a mobile device 100 that may be configured to provide or project a user interface format and content to an in-vehicle information system, such as the IVI system 125 installed in a vehicle dashboard 126 or a HUD system 131 for projecting HUD information on a windshield 130. The mobile device 100 may be configured to provide the user interface format and content via communications links 115 and/or 120, respectively. The communications links 115 and 120 may be any type of communications link capable of supporting communications between the in-vehicle information systems and the mobile device 100. According to some example embodiments, the communications links are wireless local area network (WLAN) links or personal area network (PAN) links. The communications links 115 or 120 may be wireless or wired links between the mobile device 100 and the in-vehicle information systems.

The mobile device 100 may be any type of mobile computing and communications device. According to various example embodiments, the mobile device 100 may be any type of user equipment. The mobile device 100 may be configured to communicate with an in-vehicle information system via a communications link, such as communications link 115 or 120. The mobile device 100 may also be configured to execute and implement applications via a processor and memory included within the mobile device 100. The user interface of an application being implemented by the mobile device 100 may be provided to the in-vehicle information system.

The interaction between the mobile device 100 and an in-vehicle information system provides an example of mobile device interoperability, which may also be referred to as smart space, remote environment, and remote client. In this regard, features and capabilities of the mobile device 100 may be projected onto an external remote environment, and the remote environment may appear as if the features and capabilities are inherent to remote environment such that the dependency on the mobile device 100 is not apparent to a user. According to various example embodiments, the mobile device 100 may seamlessly become a part of an in-vehicle information system, whenever the person carrying the mobile device physically enters into the intelligent space (e.g., a vehicle, or other space). Projecting the mobile device 100′s features and capabilities may involve exporting the User Interface (UI) images of the mobile device 100, as well as command and control, to the in-vehicle information system whereby, the user may comfortably interact with the in-vehicle information system in lieu of the mobile device 100.

According to some example embodiments, the mobile device 100 may be configured to, via the communications connections 115 or 120, direct an in-vehicle information system to project a user interface image originating with the mobile device 100 and receive user input provided via the in-vehicle information system. According to some example embodiments, when the mobile device 100 is providing a user interface to the in-vehicle information system, the mobile device may be referred to as being in a terminal mode. The image presented by the in-vehicle information system when the mobile device 100 is in the terminal mode may be the same image that is being presented on a display of the mobile device 100, or an image that would have been presented had the display of the mobile device been activated. In some example embodiments, when the mobile device 100 is linked to an in-vehicle information system, the user interface of the mobile device 100 may be deactivated to, for example, reduce power utilization. In some example embodiments, the image projected by the in-vehicle information system may be a translated and/or scaled image, relative to the image that would have been provided on the display of the mobile device 100, or only a portion of the image may be presented by the in-vehicle information system. For example, in a vehicle, a driver of the vehicle may wish to use the in-vehicle information system as an interface to the mobile device 100 due, for example, to the convenient location of the in-vehicle information system within the vehicle and the size of the display screen provided by the in-vehicle information system.

In this regard, the mobile device 100 may connected to the in-vehicle information system so that the driver and passengers may access applications on the mobile device 100 through the in-vehicle information system by transmitting the mobile device's user interface to the in-vehicle information system for use by the driver or passengers. The mobile device 100 may also direct audio output to the in-vehicle information system for playback through the vehicle's audio setup. The driver and/or passengers may use the input mechanisms of the in-vehicle information system, such as touch controls, knobs, and microphone to interact with and control the mobile device applications.

When the mobile device is not in a terminal mode, the user interface format of a mobile device may be designed for personal use when a user can provide full attention to the device. However, when a mobile device is in a terminal mode (providing a user interface to a remote environment), the same user interface may be distracting or difficult to use when, for example, the user is driving a vehicle. The environment of the vehicle may have an impact on the usability of the user interface typically provided by a mobile device. In some instances, the normal user interface of the mobile device may be distracting or require too much attention of the driver, thereby creating safety concerns.

According to various example embodiments, the mobile device 100 may be configured to modify a user interface format based on data acquired from a vehicle system, such as an on-board vehicle analysis system to, for example, lessen any distraction to the user/driver. A vehicle analysis system may be an on-board diagnostic (OBD) system of the vehicle. An on-board vehicle analysis system may include a communications bus that is shared by a vehicle computer and various vehicle sensors. In some example embodiments, the bus may provide a common data channel to query and access data from sensors deployed in a vehicle. The mobile device 100 may gain access to vehicle-based data, which may include vehicle sensor data, via the bus. As such, the mobile device 100 may be able to communicate with and receive data from the sensors embedded and installed in the vehicle. The mobile device 100 may communicate with the sensors either through an OBD port of the vehicle, through the vehicle's in-vehicle information system (e.g., IVI system), or through other alternate communication mechanisms.

In some example embodiments, the communications on the bus of the on-board vehicle analysis system may be provided in accordance with standard protocols such as OBD and OBD-II protocols. Sensors installed on vehicles may use the OBD or OBD-II standard. Based at least on the vehicle-based data provided by the on-board vehicle analysis system, the mobile device 100 may control the user interface format of an in-vehicle information system. In some embodiments, the vehicle-based data provided by the on-board vehicle analysis system may be accessible to the in-vehicle information system. As such, a communications connection between the mobile device and the in-vehicle information system may provide the mobile device with access to the vehicle-based data, as well as, provide a connection for transmitting a user interface to the in-vehicle information system from the mobile device.

According to various example embodiments, the mobile device 100 may be configured to consider the environmental context of the vehicle and/or the user as indicated by vehicle-based information and modify a user interface format to provide for the safe utilization of a in-vehicle information system that is receiving a user interface from a mobile device. In this regard, the mobile device may access vehicle-based data from a vehicle on-board analysis system to develop an environmental context, and modify the user interface format based on the environmental context. For example, the environmental context may be a function of the current speed of the vehicle, the amount of ambient light, the amount of ambient sound in the in the vehicle, as well as other factors. Referring again to FIG. 1, the mobile device 100 may have access to vehicle-based data 105 via a communications connection 110 (e.g., a connection to an OBD) to retrieve various data that may be leveraged to generate an environmental context. In this regard, for example, the mobile device 100 may receive speedometer data, tachometer data, light sensor data, global positioning system (GPS) data, microphone data, thermometer data, accelerator sensor data, steering sensor data, cruise control data, windshield wiper data, engine status data, gas gauge data, and the like to generate an environmental context and modify the user interface format accordingly. As mentioned above, the vehicle-based data may be accessible via a connection to the in-vehicle information system due to the in-vehicle information system having access to the vehicle-based data. As such, in some example embodiments, the vehicle-based data may be accessed by the mobile device 100 via communications connections 115 or 120.

Modifying a user interface format can involve modifying the manner in which content is output (an output mode) and/or the manner in which information is input (an input mode). In this regard, differences in the environmental context may result in changes to how content is presented on a display of an in-vehicle information system or which input devices (e.g., microphone, keypad, steering controls) may be used to input information into an in-vehicle information system. In some example embodiments where the mobile device 100 connects to an in-vehicle information system that includes both an IVI system 125 and a HUD 131, the environmental context may cause information to be provided via any one or more of the IVI system center console, the HUD, the dashboard instrument cluster display, the audio speakers, or the like. By the changing the format of the user interface, according to some example embodiments, the distraction to the driver is reduced while maximizing the relevance of the information being provided to the user and increasing the efficiency of user/in-vehicle information system interactions. Examples of a user interface formats may be a map-based navigation presentation with voice input capabilities UI format or a simplified navigation presentation (non-map-based) with only physical input capabilities UI format. Physical input may refer to input mechanisms that require user motion such as pressing a key, touching a touch screen, moving a mouse or trackball, as opposed to non-motion input such as voice. Further, in some example embodiments, the environmental context may indicate which of a plurality of communications protocols are to be used between the mobile device and an in-vehicle information system. In this regard, the type and contents of the data stream being exchanged between the mobile device and in-vehicle information system, the data stream's associated protocol of information exchange, and the underlying transport layer may be dynamically changed based on the environmental context. For example, for exchanging display contents, control information, and/or other parameters, UI streaming protocols such as Virtual Network Computing, which are capable of running on a multitude of transport layers, may be used; whereas when audio input and/or output is used, audio streaming protocols, such as Real Time Protocol (RTP), capable of running on a multitude of transport layers, may be used, or alternatively audio streaming protocols which may only run over a specific transport layer, may be used, such as Advanced Audio Distribution Profile (A2DP) over Bluetooth.

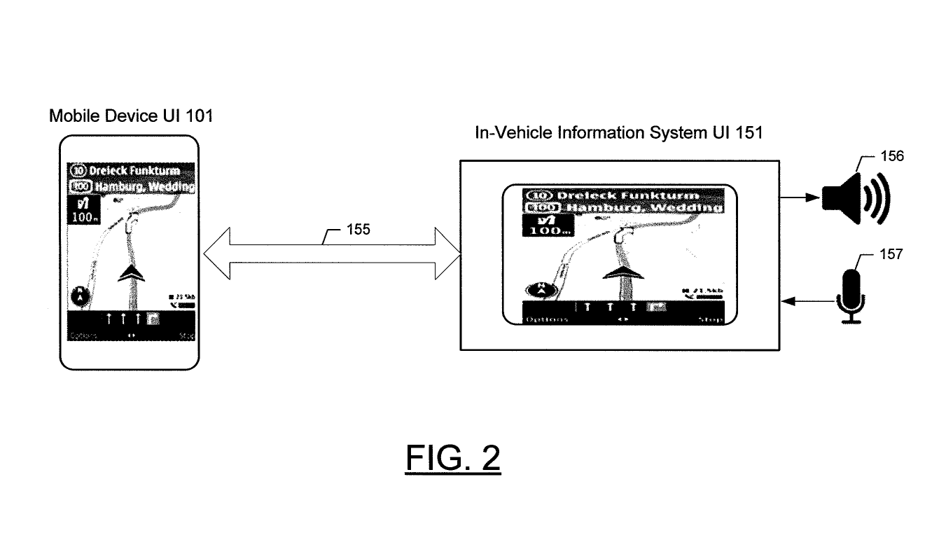

FIG. 2 illustrates a streamlined depiction of connection between a mobile device and an in-vehicle information system. Via the connection 155 (which may include any one or more of connections 110, 115 or 120), the mobile device and the in-vehicle information system may exchange input data streams, output data streams, and vehicle-based data streams (e.g., vehicle sensor data streams). Accordingly, via the connection 155 the mobile device user interface (UI) 101 may be shared to generated the in-vehicle information system UI 151. The input and output data may be provided to or received from the speakers 156 or the microphone 157 of the in-vehicle information system, respectively.

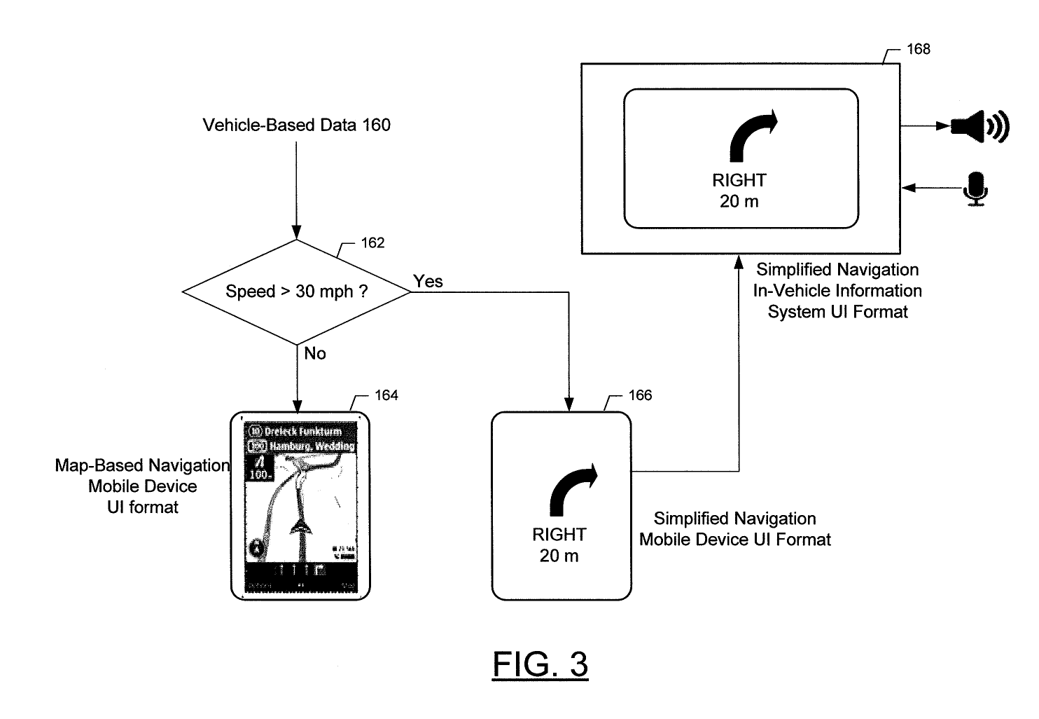

Based on the foregoing, the mobile device 100 may be configured to apply rules as a mechanism to determine the environmental context and the appropriate user interface format for the current conditions. In some example embodiments, the rules may be optionally checked for compliance and modified by the in-vehicle information system to enforce compliance with legal and manufacturer or vehicle-specific rules and regulations. FIGS. 3 through 6 depict flowcharts of example rules for use in modifying a user interface format in consideration of vehicle-based data. FIGS. 3 through 6 are provided to show some specific examples, although it is contemplated that many others could be developed based on the vehicle-based data available to the mobile device.

FIG. 3 illustrates an example of how vehicle speed data may be utilized to modify or adapt the mobile device UI format which is transmitted and shown on the display of an in-vehicle information system. In addition to other data included in the vehicle-based data 160, the mobile device may receive the vehicle speedometer readings or the vehicle's speed data. The mobile device may use the speed data to determine whether the speed exceeds a specific threshold, and thereby determine at least a portion of the environmental context. If the speed is greater than the threshold then the mobile device UI format transmitted to the in-device information system may be a simplified version with large fonts and simple graphics. At high speeds, faster driver reactions may be required, and hence, a simplified UI format, according to various example embodiments, ensures lower cognitive load and minimizes driver distraction by reducing the amount of time the driver needs to look at the display to obtain the required information.

As such, at 162, the speed data taken as vehicle-based data may be compared to a speed threshold of 30 mile per hour (mph). If the vehicle's speed is less than 30 mph, then a map-based navigation mobile device UI format may be used by the mobile device and provided to the in-vehicle information system at 164. If, on the other hand, the vehicle's speed is greater than 30 mph, a modified UI format may be used in the form of a simplified navigation mobile device UI format and implemented on the mobile device at 166. The simplified navigation UI format may then be provided to the in-vehicle information system at 168.

FIG. 3 illustrates how the mobile device may display and/or provide to the in-vehicle information system a rich graphical interface for a navigation routing program at low speeds, but switches to a simplified version at high speeds. In another example embodiment, multiple thresholds may be implemented with each threshold determining the number of content and level of content detail to be displayed.

Furthermore, in some example embodiments, a hysteresis technique may be implemented. For example, the threshold for changing from a first UI format to a second UI format may occur at 30 mph, whereas a threshold for changing from the second UI format back to the first UI format may be 25 mph. This may avoid back-and-forth oscillation in system behavior if the speed remains around the threshold (for example, in slow traffic).

According to another example embodiment, the mobile device may be configured to reduce (or increase) the number of visible elements on the display as vehicle speed increases (or decreases). As a result, no single threshold is utilized, but rather multiple thresholds are used which dictate the adaptation and modification of the mobile device UI format.

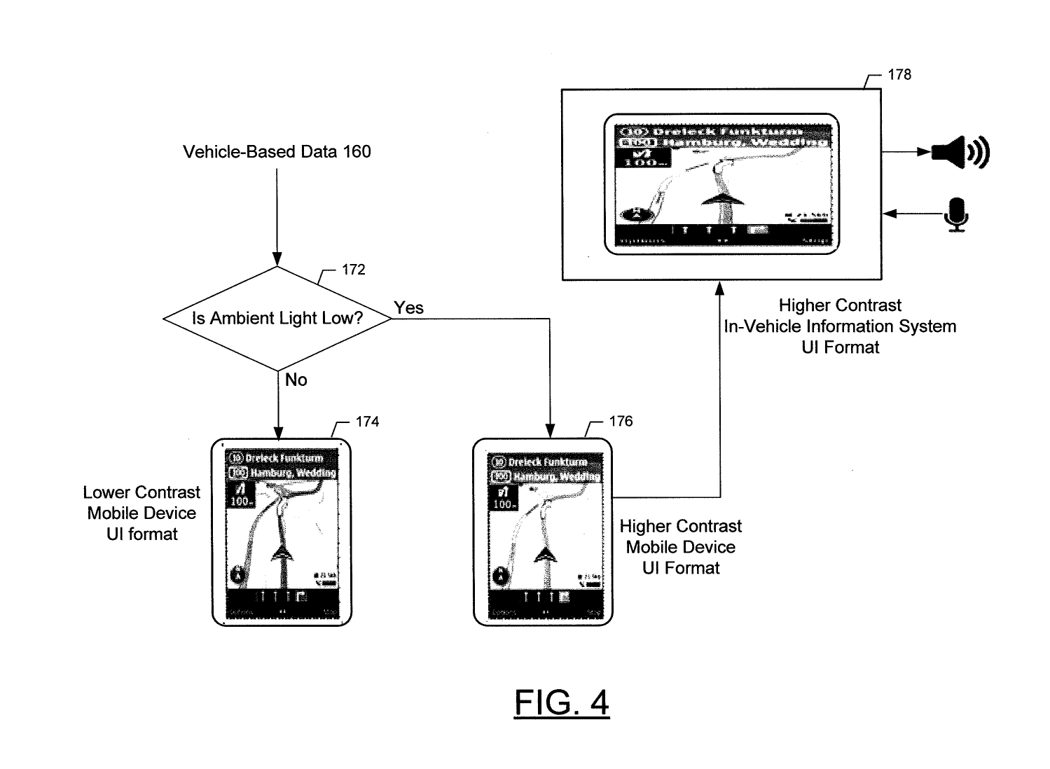

FIG. 4 illustrates an example of how ambient lighting conditions inside the vehicle may be utilized to adapt the mobile device UI format. Based on readings from the vehicle ambient light sensor, the mobile device may determine whether the lighting level inside the vehicle is low or not based on a lighting threshold. If the lighting is low, the mobile device may consider this factor of the environmental context and modify the mobile device UI format by changing the contrast level and then transmitting the modified UI format to the in-vehicle information system. According to various example embodiments, modifying the contrast ensures that the display becomes more readable to the driver and doesn't require extra attention from the driver to discern the presented content.

In this regard, at 172, the ambient light data taken as vehicle-based data 160 may be compared to a light threshold. If the vehicle's ambient light is not low, then a lower contrast mobile device UI format may be used by the mobile device and provided to the in-vehicle information system at 174. If, on the other hand, the vehicle's ambient light is low, a modified UI format may be used in the form of a higher contrast mobile device UI format and implemented on the mobile device at 176. The higher contrast UI format may then be provided to the in-vehicle information system at 178.

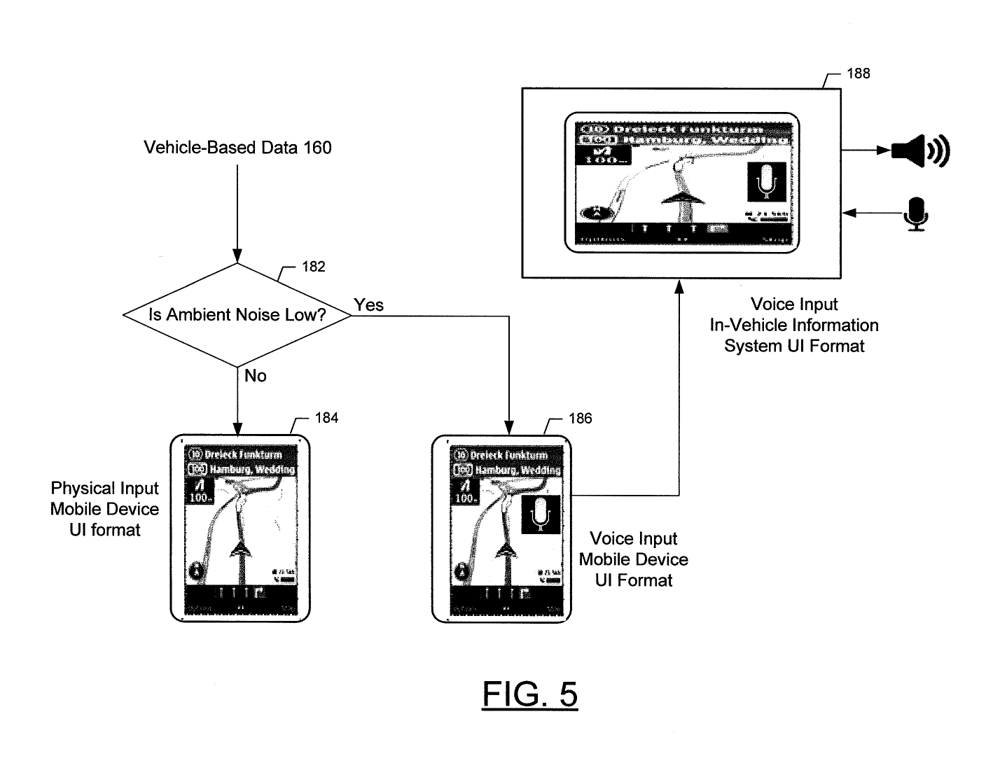

FIG. 5 illustrates an example of how noise conditions inside the vehicle may be utilized to adapt the input modalities of the mobile device. Based on noise level inputs from the vehicle's in-vehicle information system (which may be equipped with one or more microphones), the mobile device may determine whether the noise level inside the vehicle is high or low relative to a noise threshold. If the noise level is high, then voice input and/or output may be disabled and the user may interact with the mobile applications using physical input via, for example, physical controls or touch controls. If the noise level is lower than the threshold then voice input and output may be enabled. The mobile device may notify the in-vehicle information system that the in-vehicle information system may utilize audio-based input/output. The in-vehicle information system may capture audio through the vehicle's audio system and either transmit the audio stream to the mobile device directly or pre-process the audio stream (e.g., using Speech-To-Text technology), and then transmit the result to the mobile device. Similarly, the mobile device may provide audio output to the in-vehicle information system in the form of an audio stream or provide data which is converted by the in-vehicle information system into audio and played back over the vehicle's audio system.

In this regard, referring to FIG. 5 at 182, the ambient noise data taken as vehicle-based data may be compared to a noise threshold. If the vehicle's ambient noise is not low, then a physical input mobile device UI format may be used by the mobile device and provided to the in-vehicle information system at 184. If, on the other hand, the vehicle's ambient noise is low, a modified UI format may be used in the form of a voice input mobile device UI format and implemented on the mobile device at 186. The voice input UI format may then be provided to the in-vehicle information system at 188.

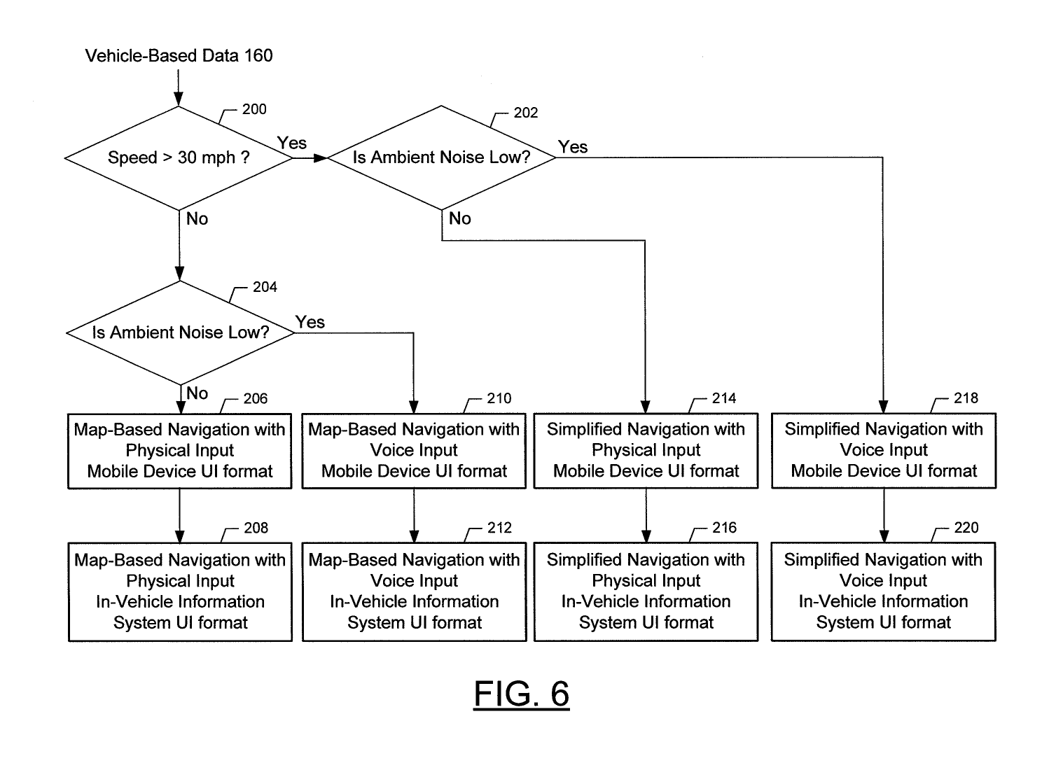

FIG. 6 illustrates an example of how multiple sensory inputs from the vehicle can be utilized to determine an environmental context and, based on the environmental context, modify or adapt the mobile device UI format. In the example embodiment of FIG. 6, two types of vehicle-based data are used—namely, speed and ambient noise data—to determine the UI format. However, it is contemplated that any number and/or combination of data types or vehicle-based data parameters may be considered as part of the environmental context to determine how to modify the UI format. Based on inputs from the vehicle speedometer, the mobile device may determine whether the speed is higher or lower than a specific threshold and, as a result, whether a map-based or simplified navigation UI format may be used. Additionally, based on inputs from the in-vehicle microphones, the mobile device may determine whether the ambient noise is higher or lower than a specific threshold and, as a result, whether a physical or voice input UI format may be used.

In this regard, referring to FIG. 6 at 200, the speed data taken as vehicle-based data 160 may be compared to a speed threshold of 30 mile per hour (mph). If the vehicle's speed is less than 30 mph, then the ambient noise data taken as vehicle-based data 160 may be compared to a noise threshold at 204. If the vehicle's ambient noise is not low and the speed is under 30 mph, then map-based navigation with physical input mobile device UI format may be used by the mobile device at 206 and provided to the in-vehicle information system at 208. If the vehicle's ambient noise is low and the speed is under 30 mph, then map-based navigation with voice input mobile device UI format may be used by the mobile device at 210 and provided to the in-vehicle information system at 212. Further, if the speed is above 30 mph at 200, then the ambient noise data may be compared to a noise threshold at 202. If the vehicle's ambient noise is not low and the speed is above 30 mph, then a simplified navigation with physical input mobile device UI format may be used by the mobile device at 214 and provided to the in-vehicle information system at 216. If the vehicle's ambient noise is low and the speed is above 30 mph, then a simplified navigation with voice input mobile device UI format may be used by the mobile device at 218 and provided to the in-vehicle information system at 220. As another example utilization of multiple types of vehicle-based data or sensor inputs, a UI format may be determined that causes presented output to be re-directed to an alternate display inside the vehicle, such as from an IVI center console display to a windshield HUD or an instrument cluster display.

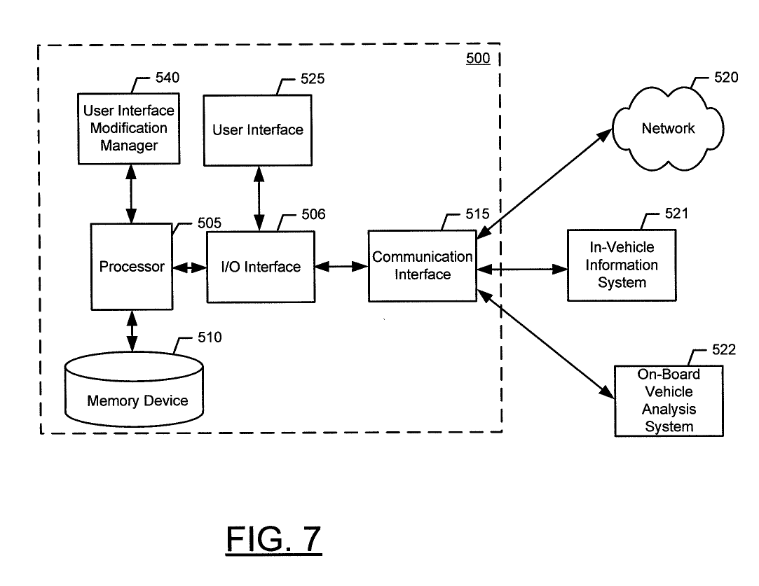

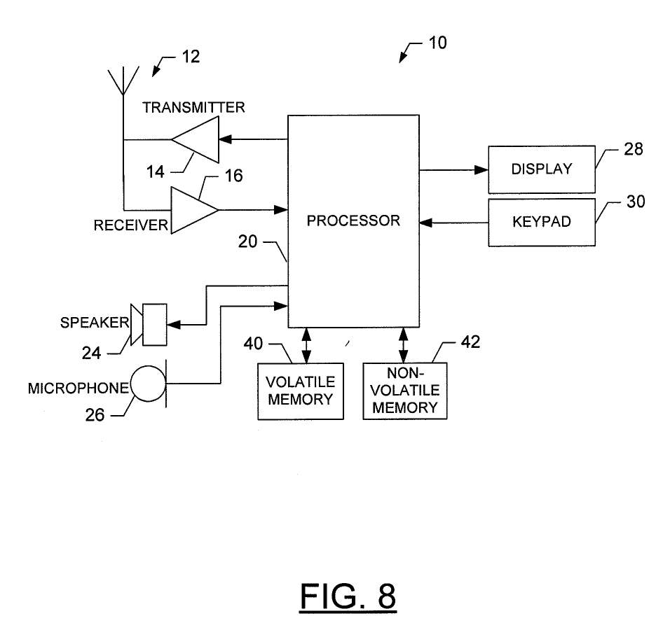

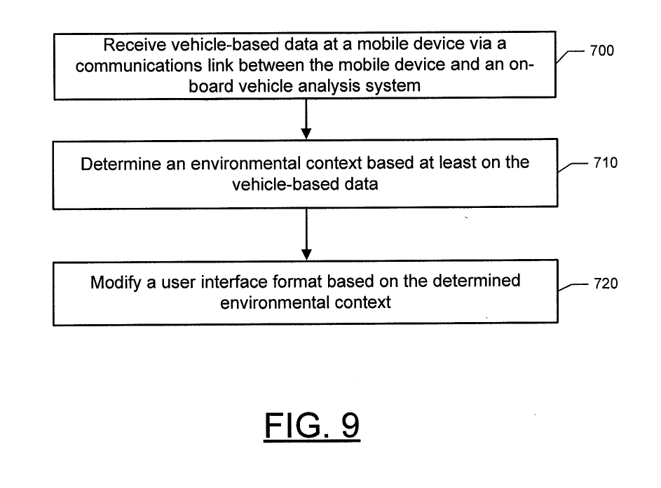

The description provided above and generally herein illustrates example methods, example apparatuses, and example computer program products for modifying a user interface format. FIGS. 7 and 8 depict example apparatuses that may be configured to perform various functionalities as described herein, including those described with respect to the descriptions of FIGS. 1-6 provided above, with respect to the flowchart of FIG. 9, and the operations and functionality otherwise described herein.

Referring now to FIG. 7, an example embodiment of the present invention is depicted as apparatus 500. The mobile device 100 may be an example embodiment of apparatus 500. In some example embodiments, the apparatus 500 need not include wireless communications functionality, but in other example embodiments, the apparatus 500 may, be embodied as, or included as a component of, a communications device with wired and/or wireless communications capabilities. In some example embodiments, the apparatus 500 may be part of a communications device, such as a stationary or a mobile communications terminal. As a mobile device, the apparatus 500 may be a mobile and/or wireless communications node such as, for example, a mobile and/or wireless server, computer, access point, handheld wireless device (e.g., telephone, portable digital assistant (PDA), mobile television, gaming device, camera, video recorder, audio/video player, radio, digital book reader, and/or a global positioning system (GPS) device), any combination of the aforementioned, or the like. Regardless of the type of communications device, apparatus 500 may also include computing capabilities.

FIG. 7 illustrates a block diagram of example components of the apparatus 500. The example apparatus 500 comprises or is otherwise in communication with a processor 505, a memory device 510, an Input/Output (I/O) interface 506, a user interface 525, a communications interface 515, and a and an user interface modification manager 540. The processor 505 may, according to some example embodiments, be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 505 may be representative of a plurality of processors, or one or more multiple core processors, operating in concert. Further, the processor 505 may be comprised of a plurality of transistors, logic gates, a clock (e.g., oscillator), other circuitry, and the like to facilitate performance of the functionality described herein. The processor 505 may, but need not, include one or more accompanying digital signal processors. In some example embodiments, the processor 505 is configured to execute instructions stored in the memory device 510 or instructions otherwise accessible to the processor 505. The processor 505 may be configured to operate such that the processor causes or directs the apparatus 500 to perform various functionalities described herein.

Whether configured as hardware or via instructions stored on a computer-readable storage medium, or by a combination thereof, the processor 505 may be an entity and means capable of performing operations according to embodiments of the present invention while configured accordingly. Thus, in example embodiments where the processor 505 is embodied as, or is part of, an ASIC, FPGA, or the like, the processor 505 is specifically configured hardware for conducting the operations described herein. Alternatively, in example embodiments where the processor 505 is embodied as an executor of instructions stored on a computer-readable storage medium, the instructions specifically configure the processor 505 to perform the algorithms and operations described herein. In some example embodiments, the processor 505 is a processor of a specific device (e.g., a communications server or mobile device) configured for employing example embodiments of the present invention by further configuration of the processor 505 via executed instructions for performing the algorithms, methods, and operations described herein.

The memory device 510 may be one or more tangible and/or non-transitory computer-readable storage media that may include volatile and/or non-volatile memory. In some example embodiments, the memory device 510 comprises Random Access Memory (RAM) including dynamic and/or static RAM, on-chip or off-chip cache memory, and/or the like. Further, memory device 510 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 510 may include a cache area for temporary storage of data. In this regard, some or all of memory device 510 may be included within the processor 505. In some example embodiments, the memory device 510 may be in communication with the processor 505 and/or other components via a shared bus.

Further, the memory device 510 may be configured to store information, data, applications, computer-readable program code instructions, and/or the like for enabling the processor 505 and the example apparatus 500 to carry out various functions in accordance with example embodiments of the present invention described herein. For example, the memory device 510 may be configured to buffer input data for processing by the processor 505. Additionally, or alternatively, the memory device 510 may be configured to store instructions for execution by the processor 505.

The I/O interface 506 may be any device, circuitry, or means embodied in hardware, software, or a combination of hardware and software that is configured to interface the processor 505 with other circuitry or devices, such as the communications interface 515. In some example embodiments, the I/O interface may embody or be in communication with a bus that is shared by multiple components. In some example embodiments, the processor 505 may interface with the memory 510 via the I/O interface 506. The I/O interface 506 may be configured to convert signals and data into a form that may be interpreted by the processor 505. The I/O interface 506 may also perform buffering of inputs and outputs to support the operation of the processor 505. According to some example embodiments, the processor 505 and the I/O interface 506 may be combined onto a single chip or integrated circuit configured to perform, or cause the apparatus 500 to perform, various functionalities of the present invention.

In some embodiments, the apparatus 500 or some of the components of apparatus 500 (e.g., the processor 505 and the memory device 510) may be embodied as a chip or chip set. In other words, the apparatus 500 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 500 may therefore, in some cases, be configured to implement embodiments of the present invention on a single chip or as a single “system on a chip.” As such, in some cases, a chip or chipset may constitute means for performing the functionalities described herein and with respect to the processor 505.

The communication interface 515 may be any device or means embodied in hardware, a computer program product, or a combination of hardware and a computer program product that is configured to receive and/or transmit data from/to a network 520 and/or any other device or module in communication with the example apparatus 500. In this regard, the communications interface 515 may also be configured to communications between the apparatus 500 and an in-vehicle information system 521 (e.g., an IVI device, or a HUD), and/or between the apparatus 500 and an on-board vehicle analysis system 522 (e.g., an OBD system).

The communications interface may be configured to communicate information via any type of wired or wireless connection, and via any type of communications protocol, such as a communications protocol that supports cellular communications. According to various example embodiments, the communication interface 515 may be configured to support the transmission and reception of communications in a variety of networks including, but not limited to Internet Protocol-based networks (e.g., the Internet), cellular networks, or the like. Further, the communications interface 515 may be configured to support device-to-device communications. Processor 505 may also be configured to facilitate communications via the communications interface 515 by, for example, controlling hardware included within the communications interface 515. In this regard, the communication interface 515 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 515, the example apparatus 500 may communicate with various other network entities in a device-to-device fashion and/or via indirect communications via a base station, access point, server, gateway, router, or the like.

The user interface 525 may be in communication with the processor 505 to receive user input via the user interface 525 and/or to present output to a user as, for example, audible, visual, mechanical, or other output indications. The user interface 525 may include, for example, a keyboard, a mouse, a joystick, a display (e.g., a touch screen display), a microphone, a speaker, camera, accelerometer, or other input/output mechanisms. Further, the processor 505 may comprise, or be in communication with, user interface circuitry configured to control at least some functions of one or more elements of the user interface. The processor 505 and/or user interface circuitry may be configured to control one or more functions of one or more elements of the user interface through computer program instructions (e.g., software and/or firmware) stored on a memory accessible to the processor 505 (e.g., volatile memory, non-volatile memory, and/or the like). The user interface 525 may also be configured to support the implementation of haptic feedback. In this regard, the user interface 525, as controlled by processor 505, may include a vibra, a piezo, and/or an audio device configured for haptic feedback as described herein. In some example embodiments, the user interface circuitry is configured to facilitate user control of at least some functions of the apparatus 500 through the use of a display and configured to respond to user inputs. The processor 505 may also comprise, or be in communication with, display circuitry configured to display at least a portion of a user interface, the display and the display circuitry configured to facilitate user control of at least some functions of the apparatus 500.

In addition to or in lieu of, some of the user input and out devices described above, the user interface 525 may include, as mentioned above, one or more touch screen displays. A touch screen display may be configured to visually present graphical information to a user, as well as receive user input via a touch sensitive screen. The touch screen display, which may be embodied as any known touch screen display, may also include a touch detection surface configured to enable touch recognition by any suitable technique, such as resistive, capacitive, infrared, strain gauge, surface wave, optical imaging, dispersive signal technology, acoustic pulse recognition, or other like techniques. In some example embodiments, the touch screen display may be configured to operate in a hovering mode, where movements of a finger, stylus, or other implement can be sensed when sufficiently near the touch screen surface, without physically touching the surface. The touch screen displays may include all of the hardware necessary to detect a touch when contact is made with the touch detection surface and send an indication to, for example, processor 505 indicating characteristics of the touch such as location information. A touch event may occur when an object, such as a stylus, finger, pen, pencil or any other pointing device, comes into contact with a portion of the touch detection surface of the touch screen display in a manner sufficient to register as a touch. The touch screen display may therefore be configured to generate touch event location data indicating the location of the touch event on the screen.

The user interface modification manager 540 of example apparatus 500 may be any means or device embodied, partially or wholly, in hardware, a computer program product, or a combination of hardware and a computer program product, such as processor 505 implementing stored instructions to configure the example apparatus 500, memory device 510 storing executable program code instructions configured to carry out the functions described herein, or a hardware configured processor 505 that is configured to carry out the functions of the user interface modification manager 540 as described herein. In an example embodiment, the processor 505 comprises, or controls, the user interface modification manager 540. The user interface modification manager 540 may be, partially or wholly, embodied as processors similar to, but separate from processor 505. In this regard, the user interface modification manager 540 may be in communication with the processor 505. In various example embodiments, the user interface modification manager 540 may, partially or wholly, reside on differing apparatuses such that some or all of the functionality of the user interface modification manager 540 may be performed by a first apparatus, and the remainder of the functionality of the user interface modification manager 540 may be performed by one or more other apparatuses.

Further, the apparatus 500 and the processor 505 may be configured to perform the following functionality via user interface modification manager 540 as well as other functionality described herein. The user interface modification manager 540 may be configured to cause or direct means such as the processor 505 and/or the apparatus 500 to perform various functionalities, such as those described with respect to FIGS. 1-6, and 9, and as generally described herein.

For example, with reference to FIG. 9, the user interface modification manager 540 may be configured to receive vehicle-based data via a communications link to an on-board vehicle analysis system 522 at 700. According to some example embodiments, the received vehicle-based data may include representations of information provided by vehicle sensors of the on-board vehicle analysis system. Further, according to some example embodiments, the communications link to the on-board vehicle analysis system 522 uses an on-board diagnostic (OBD) protocol (e.g., OBD-II protocol).

Additionally, the user interface modification manager 540 may be configured to determine an environmental context based at least on the vehicle-based data at 710, and modify a user interface format based on the determined environmental context at 720. In this regard, according to some example embodiments, the user interface format may be a user interface format that is transmitted from the apparatus 500 to an in-vehicle information system 521. In some example embodiments, modifying the user interface format may include modifying a displayed output mode based on the determined environmental context and/or modifying a user input mode based on the determined environmental context. Further, in some example embodiments, modifying the user interface format may include modifying a communications protocol used to transmit and receive information between the mobile device and an in-vehicle information system.

Referring now to FIG. 8, a more specific example apparatus in accordance with various embodiments of the present invention is provided. The example apparatus of FIG. 8 is a mobile terminal 10 configured to communicate within a wireless network, such as a cellular communications network. The mobile terminal 10 may be configured to perform the functionality of the mobile terminal 100 or apparatus 500 as described herein. More specifically, the mobile terminal 10 may be caused to perform the functionality described with respect to FIGS. 1-6 and/or 9, via the processor 20. In this regard, according to some example embodiments, the processor 20 may be configured to perform the functionality described with respect to the user interface modification manager 540. Processor 20 may be an integrated circuit or chip configured similar to the processor 505 together with, for example, the I/O interface 506. Further, volatile memory 40 and non-volatile memory 42 may be configured to support the operation of the processor 20 as computer readable storage media.

The mobile terminal 10 may also include an antenna 12, a transmitter 14, and a receiver 16, which may be included as parts of a communications interface of the mobile terminal 10. The speaker 24, the microphone 26, display 28 (which may be a touch screen display), and the keypad 30 may be included as parts of a user interface.

FIGS. 3-6 and 9 illustrate flowcharts of example systems, methods, and/or computer program products according to example embodiments of the invention. It will be understood that each operation of the flowcharts, and/or combinations of operations in the flowcharts, can be implemented by various means. Means for implementing the operations of the flowcharts, combinations of the operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIGS. 3-6 and 9 and otherwise described herein may be stored on a memory device, such as memory device 510, volatile memory 40, or volatile memory 42, of an example apparatus, such as example apparatus 500 or mobile terminal 10, and executed by a processor, such as the processor 505 or processor 20. As will be appreciated, any such program code instructions may be loaded onto a computer or other programmable apparatus (e.g., processor 505, memory device 510, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
receiving vehicle-based data at a mobile device via a communications link between the mobile device and an on-board vehicle analysis system;
determining an environmental context based at least on the vehicle-based data; and
modifying a user interface format based on the determined environmental context.

2. The method of claim 1, wherein modifying the user interface format includes modifying the user interface format, the user interface format being transmitted from the mobile device to an in-vehicle information system.

3. The method of claim 1, wherein receiving the vehicle-based data includes receiving the vehicle-based data, the vehicle-based data including representations of information provided by vehicle sensors of the on-board vehicle analysis system.

4. The method of claim 1, wherein modifying the user interface format includes modifying a displayed output mode based on the determined environmental context.

5. The method of claim 1, wherein modifying the user interface format includes modifying a user input mode based on the determined environmental context.

6. The method of claim 1, wherein modifying the user interface format includes modifying a communications protocol used to transmit and receive information between the mobile device and an in-vehicle information system.

7. The method of claim 1, wherein receiving the vehicle-based data includes receiving the vehicle-based data at the mobile device via the communications link between the mobile device and the on-board vehicle analysis system, wherein the communications link to the on-board vehicle analysis system uses an on-board diagnostic (OBD) protocol.

8. An apparatus comprising at least one processor and at least one memory including computer program code, the at least one memory and the computer program code configured to, with the at least one processor, direct the apparatus at least to:
receive vehicle-based data at a mobile device via a communications link between the mobile device and an on-board vehicle analysis system;
determine an environmental context based at least on the vehicle-based data; and
modify a user interface format based on the determined environmental context.

9. The apparatus of claim 8, wherein the apparatus directed to modify the user interface format includes being directed to modify the user interface format, the user interface format being transmitted from the mobile device to an in-vehicle information system.

10. The apparatus of claim 8, wherein the apparatus directed to receive the vehicle-based data includes being directed to receive the vehicle-based data, the vehicle-based data including representations of information provided by vehicle sensors of the on-board vehicle analysis system.

11. The apparatus of claim 8, wherein the apparatus directed to modify the user interface format includes being directed to modify a displayed output mode based on the determined environmental context.

12. The apparatus of claim 8, wherein the apparatus directed to modify the user interface format includes being directed to modify a user input mode based on the determined environmental context.

13. The apparatus of claim 8, wherein the apparatus directed to modify the user interface format includes being directed to modify a communications protocol used to transmit and receive information between the mobile device and an in-vehicle information system.

14. The apparatus of claim 8, wherein the apparatus directed to receive the vehicle-based data includes being directed to receive the vehicle-based data at the mobile device via the communications link between the mobile device and the on-board vehicle analysis system, wherein the communications link to the on-board vehicle analysis system uses an on-board diagnostic (OBD) protocol.

15. The apparatus of claim 8, wherein the apparatus comprises the mobile device.

16. The apparatus of claim 15, wherein the apparatus further comprises a transmitter for transmitting the modified user interface format.

17. A computer program product comprising a non-transitory memory having program code stored thereon, the program code configured to direct an apparatus to:
receive vehicle-based data at a mobile device via a communications link between the mobile device and an on-board vehicle analysis system;
determine an environmental context based at least on the vehicle-based data; and
modify a user interface format based on the determined environmental context.

18. The computer program product of claim 17, wherein the program code configured to direct the apparatus to modify the user interface format includes being configured to direct the apparatus to modify the user interface format, the user interface format being transmitted from the mobile device to an in-vehicle information system.

19. The computer program product of claim 17, wherein the program code configured to direct the apparatus to receive the vehicle-based data includes being configured to direct the apparatus to receive the vehicle-based data, the vehicle-based data including representations of information provided by vehicle sensors of the on-board vehicle analysis system.

20. The computer program product of claim 17, wherein the program code configured to direct the apparatus to receive the vehicle-based data includes being configured to direct the apparatus to receive the vehicle-based data at the mobile device via the communications link between the mobile device and the on-board vehicle analysis system, wherein the communications link to the on-board vehicle analysis system uses an on-board diagnostic (OBD) protocol.
